(19) United States
(12) Patent Application Publication
(10) Pub. No.: US 2013/0166461 A1
(43) Pub. Date: Jun. 27, 2013

(54) INTELLECTUAL ASSET SURVEY DESIGN AND INTEGRATION

(71) Applicant: Anaqua, Inc., Boston, MA (US)

(72) Inventor: Paul Austin, Rayleigh (GB)

(73) Assignee: Anaqua, Inc., Boston, MA (US)

(21) Appl. No.: 13/720,007

(22) Filed: Dec. 19, 2012

Related U.S. Application Data
(60) Provisional application No. 61/579,306, filed on Dec. 22, 2011.

(51) Int. Cl. G06Q 50/18; G06Q 10/00

(52) U.S. Cl. CPC G06Q 50/184; G06Q 10/00
USPC 705/310

(57) ABSTRACT

Example embodiments relate to a method, server, and computer-readable media for survey design for creation and management of intellectual asset records and workflow within an intellectual asset management system. A new intellectual asset survey template is created by providing survey components to an IAM system administrator via an IAM system user interface and enabling the IAM system administrator to organize the survey components on a preview area of the user interface. A runtime survey, based at least in part on the intellectual asset survey template, is displayed on the IAM system user interface. Intellectual asset record data units are affected by user answers and hidden questions in the survey, and workflow can be triggered through predetermined conditions associated with the user input into the survey. The runtime survey may also be displayed only to a predetermined set of IAM system users.

### CROSS-REFERENCE TO RELATED APPLICATIONS

This application claims the benefit of and priority to U.S. Provisional Application No. 61/579,306, filed on December 22, 2011 which is incorporated herein by reference.

### TECHNICAL FIELD

Embodiments relate generally to survey design and utilization and, more particularly, to a method, server, and computer-readable media for survey design for creation and management of intellectual asset records and workflow within an intellectual asset management system.

### BACKGROUND

An intellectual asset management (IAM) system is used to schedule legal matters and manage aspects of intellectual property assets. Examples of intellectual property assets may include: patents, trade secrets, publications, trademarks, domain names, copyrights, and applications or filings thereof. An IAM system typically supports docketing and other related activities in the full lifecycle of intellectual property assets, such as invention disclosure submission, trademark search requests, multi-party collaboration, document and e-mail management, configurable business workflow rules, and business intelligence tools, among other features. An IAM system provides visibility and access to internal and external participants in the intellectual asset management process—for example, attorneys, agents and paralegals, researchers and engineers, portfolio managers, marketing, licensing professionals and other business managers.

A challenge facing IAM users—in particular attorneys, agents, and paralegals—of intellectual asset management systems is proper entry of all the various information associated with intellectual assets. IAM users, when creating a new intellectual asset record to store metadata for a particular intellectual asset, typically do not want to be required to input information for all fields of the record; they prefer to leverage pre-configured default values for many fields; and they often would like to not even be presented certain fields which are not applicable for the specific type or subtype of an intellectual asset. As an example, an intellectual asset management system might handle the design intellectual asset type as a subtype of the patent intellectual asset type—while designs in the United States are treated as design patents, designs are not handled as patents in many other jurisdictions around the world, so many patent intellectual asset record fields are not applicable for designs. Thus, an IAM user might prefer to not see those non-applicable fields when creating or updating an intellectual asset record for a design. Additionally, IAM users would enjoy productivity and data quality gains and advantages through having the flexibility of being able to create their own intellectual asset record creation surveys, thereby not being constrained to the default entry and creation interfaces provided by an intellectual asset management system. In addition, IAM users would prefer to be able to utilize different survey forms for different situations, processes, and/or organizational divisions within a company or law firm.

### SUMMARY

In some embodiments, a method, server, and computer-readable media are provided for survey design for creation and management of intellectual asset records and workflow within an intellectual asset management system.

Some embodiments provide a method, server, and computer-readable media for creating a new survey template by providing survey components to an IAM system administrator via an IAM system user interface and enabling the IAM system administrator to organize the survey components on a preview area of the user interface. Other embodiments provide a method, server, and computer-readable media for displaying a runtime survey on the IAM system user interface, wherein the runtime survey is based at least in part on the intellectual asset survey template. Additional embodiments provide a method, server, and computer-readable media for accepting input from an IAM system user into the runtime survey and populating at least one data unit within an intellectual asset record stored in the IAM system based at least in part on the user input or based on a hidden question. Alternatively or additionally, some embodiments execute predefined workflow based upon a condition triggered by the user input within the runtime survey. Other embodiments provide a method, server, and computer-readable media to design a survey and display the runtime survey only to a predetermined set of IAM system users.

Additional features and advantages of claimed subject matter will be set forth in the description which follows, and in part will be obvious from the description, or may be learned by the practice of embodiments. The features and advantages of various embodiments may be realized and obtained by means of the instruments and combinations particularly pointed out in the appended claims. These and other features of example embodiments will become more fully apparent from the following description and appended claims, or may be learned by the practice of embodiments as set forth hereinafter.

### BRIEF DESCRIPTION OF THE DRAWINGS

To further clarify the above and other advantages and features of the present application, a more particular description the subject matter of this application will be rendered by reference to specific embodiments thereof which are illustrated in the appended drawings. It is appreciated that these drawings depict only example embodiments and are therefore not to be considered to limit scope of the present application. Example embodiments will be described and explained with additional specificity and detail through the use of the accompanying drawings in which:

FIG. 1A illustrates an example IAM system including an example IAM server.

FIG. 1B illustrates an example IAM server of the IAM system of FIG. 1A.

FIG. 2 illustrates example data that may be stored as part of an intellectual asset record on the IAM server of FIG. 1B.

FIG. 3 is a block diagram illustrating an example user interface object that may be included in the IAM system of FIG. 1A for drag-and-drop survey template creation for intellectual asset record information entry, storage, update, and workflow in accordance with an example embodiment.

FIGS. 4A and 4B are block diagrams depicting example design menus utilized for intellectual asset survey template design.

FIG. 5A illustrates an example invention disclosure survey template.

FIG. 5B illustrates an example invention disclosure runtime survey.

FIGS. 6A, 6B, 6C, and 6D illustrate example question properties for various types of survey questions.

FIG. 7 illustrates an example user interface object for editing a survey data group;

FIG. 8 is a block diagram depicting an example user interface object for editing survey approval properties.

FIG. 9 illustrates an example completed and saved invention disclosure survey.

FIG. 10 illustrates an example method for creating an intellectual asset record and triggering workflow based upon survey submission.

FIG. 11 provides a block diagram illustrating a suitable computing environment in which several embodiments may be implemented.

### DETAILED DESCRIPTION

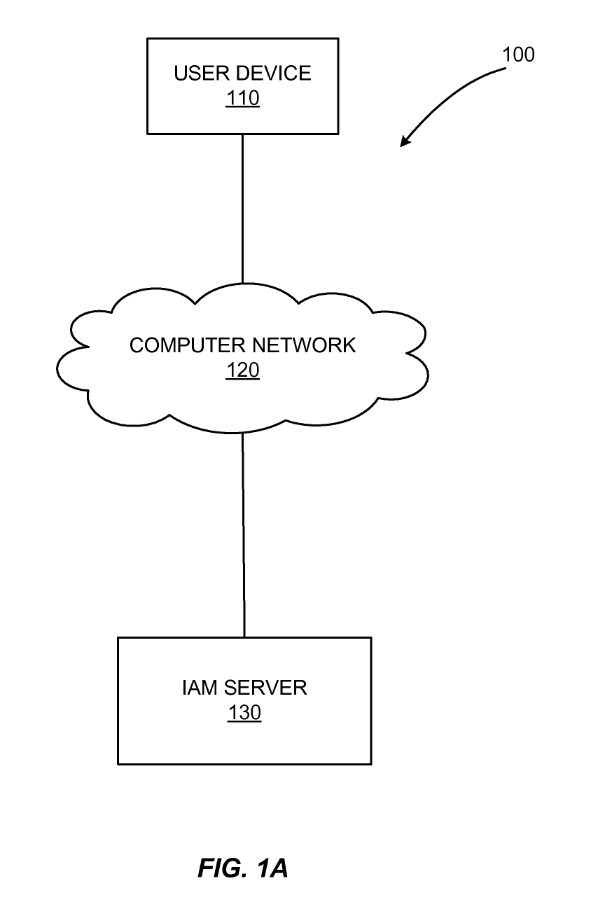

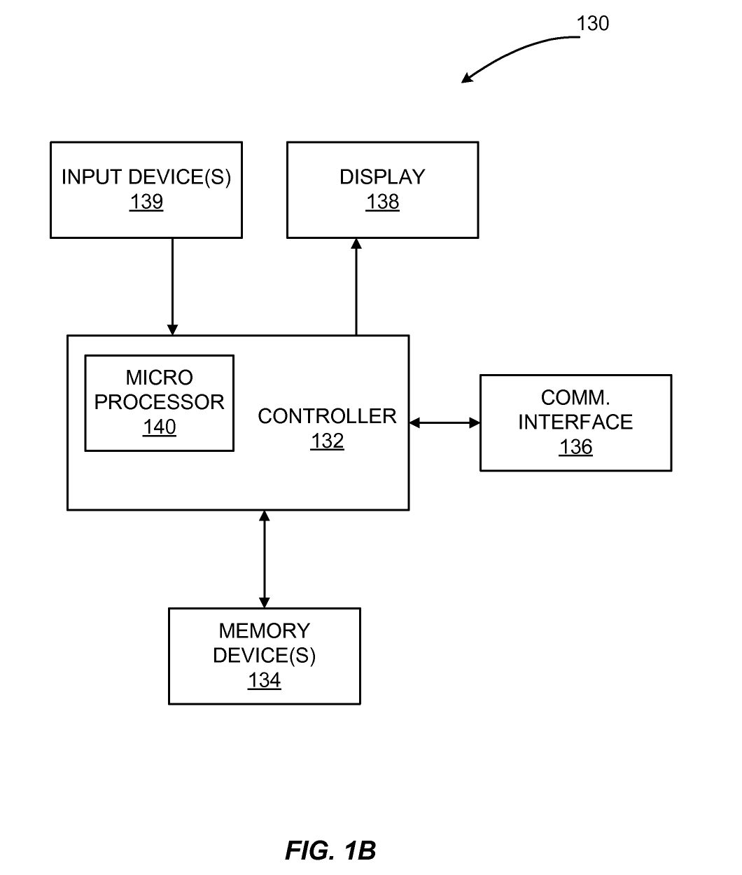

FIG. 1A illustrates an example IAM system 100. The IAM system 100 generally provides one or more IAM users (not shown) with an IAM service (not shown). The IAM system 100 may include a user device 110 communicatively coupled to an IAM server 130 via a computer network 120. The coupling between the IAM server 130 and the user device 110 may enable the IAM user to access at least some portion of an IAM service stored or otherwise available on the IAM server 130.

The IAM service may generally schedule legal matters pertaining to intellectual assets and manage aspects of those legal matters. For example, an intellectual property docketing service may support scheduling a disclosure submission and manage the related filing dates such as provisional application filing, non-provisional conversion dates, maintenance fees, and the like. The management and scheduling of these legal matters may be managed by an IAM server application (described below) which may include a set of templates, data, instructions, applications, computer programs, or some combination thereof. Alternatively or additionally, the IAM system 100 may provide a visible and accessible, user interface to internal and external entities through which the legal matters are managed. Specifically, as described herein, the IAM service may include various IAM server applications that include one or more user interface (UI) objects, for instance, to enable the IAM user to manage surveys.

The user device 110 in FIG. 1A may be a desktop computer, a laptop computer, a portable electronic device such as a cellular/mobile/smart phone, a tablet personal computer, a personal digital assistant, or any other suitable device. The user device 110 may include IAM client software to access the IAM server 130, or the user device 110 may include a web browser to access the IAM server 130, where the IAM server 130 provides the IAM service as a web application. Alternatively, the user device 110 may communicate with the IAM server 130 through other means, such as a remote desktop connection.

Additionally, the user device 110 communicates with the IAM server 130 via the computer network 120. The computer network 120 relates to a collection of devices interconnected by communication channels that allows sharing of information among the interconnected devices. In this example embodiment, the computer network 120 may be or include any wired or wireless network technology such as optical fiber, electrical cables, Ethernet, radio wave, microwaves, infrared transmission, wireless internet, communication satellites, cellular telephone signals, or an equivalent networking signal that interfaces with devices to create network. Specifically, in one embodiment, the user device 110 communicates with the IAM server 130 via the internet. In other embodiments, the user device 110 may be directly coupled with the IAM server 130 and/or may be integrated directly with, and be a part of, the IAM server 130.

In FIG. 1A, one user device 110 is operably connected to communicate with the IAM server 130 via the computer network 120. However, in alternative embodiments a plurality of user devices 110 which may include various types of user devices 110 may simultaneously communicate with the IAM server 130. Additionally or alternatively, the IAM system 100 may include multiple IAM servers 130 which are operably connected to communicate information among the multiple IAM servers 130 and/or to communicate information among various user devices 110 operably connected to communicate with the IAM servers 130.

FIG. 1B illustrates additional details of the IAM server 130 of FIG. 1A. As depicted in FIG. 1B, the IAM server 130 may include a controller 132 and a memory device 134. The controller 132 may include a microprocessor 140 which executes an IAM server application (not shown). The IAM server application may include templates, data, instructions, applications, or computer programs stored in the memory device 134. The IAM server application may vary as necessary to implement the IAM service.

In the embodiment illustrated in FIG. 1B, the controller 132 is operatively coupled to the memory device 134, which enables the controller 132 through the microprocessor 140 to access information stored on the memory device 134 such as the IAM server applications, an intellectual asset record (IA record) (described below), and/or a file (described below). The memory device 134 may provide data to the controller 132 in various forms, such as, but not limited to, database records, files, bitstreams, and bytestreams, and the memory device 134 may include volatile or non-volatile memory or storage.

As depicted in FIG. 1B, the docket server 130 may include a single controller 132, which may include a microprocessor 140 that executes an IAM server application, and a single memory device 134. However, in alternative embodiments, the docket server 130 may include one or more controllers 132, one or more microprocessors 140 which execute a plurality of IAM server applications, and one or more memory devices 134. The one or more memory devices 134 may be remotely located from each other and/or from the controller 132.

The IAM server 130 may include a communication interface 136. The communication interface 136 enables the IAM server 130 to communicate with a user device via a computer network. For example, with combined reference to FIGS. 1A and 1B, the communication interface 136 may enable the user device 110 to communicate to the IAM server 130 via the computer network 120. Additionally, the communication interface 136 may enable the IAM server 130 to communicate with other IAM server applications either publically or privately available on the internet or through an interface between multiple IAM servers 130, which are operably connected via the computer network 120. Examples of the communication interface 136 include any receiver or transmitter capable of functioning with the computer network 120.

Referring back to FIG. 1B, the IAM server 130 may further include a display 138 and one or more input devices 139. The IAM user (not shown) and/or an IAM server administrator (not shown) may directly interface and control the IAM server 130 through the display 138 and the input devices 139. Examples of the display 138 may include a thin film transistor liquid crystal display, liquid crystal display, or an equivalent structure. Examples of the input devices 139 may include a QWERTY key pad, a ten key input pad, a mouse, a stylus, voice recognition software, an audio mixer, or may be integrated with the display 138 as in a touchscreen device using a surface acoustic wave, surface capacitance, projected capacitance, or an equivalent structure.

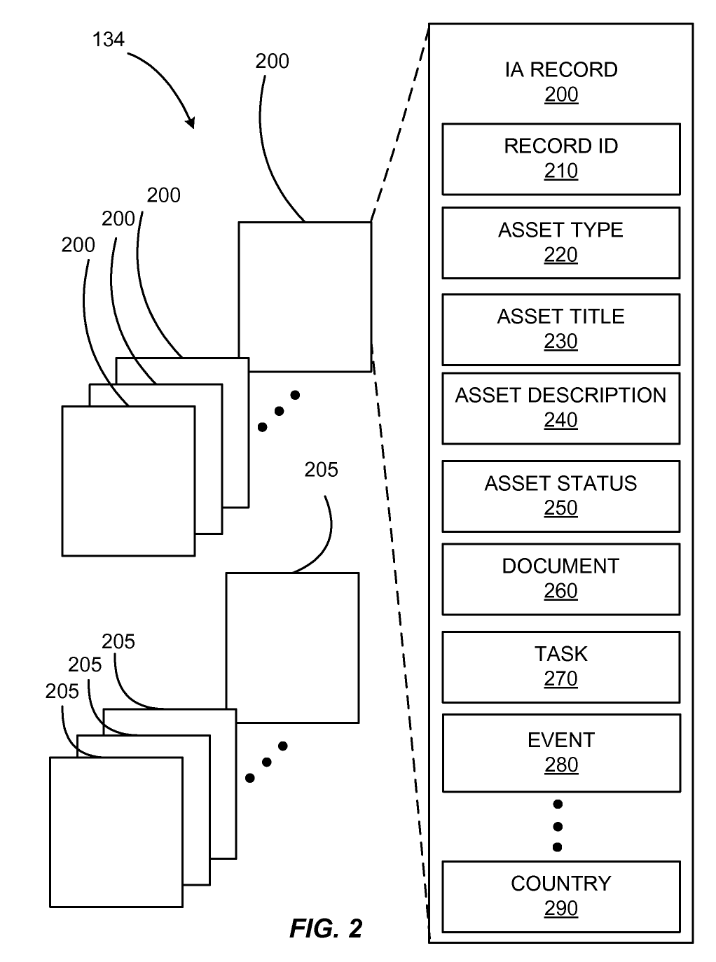

Turning next to FIG. 2, additional details of the memory device 134 of FIG. 1B are disclosed. FIG. 2 illustrates data that may be stored in the memory device 134. Specifically, in some embodiments the data may include intellectual asset records (IA record) 200 and/or files 205. The files 205 may include one or more of any type of computer file readable by one or more computer programs, and examples of the files 205 include one or more of: text files; image files such as PNG, GIF, JPG, etc.; PDF files; etc.

In alternative embodiments, the files 205 and the IA records 200 may be stored separately. For example, the files 205 may be stored on a first memory device and the IA records 200 may be stored on a second memory device. In this and other example embodiments, the first memory device may be located in an IAM server such as the IAM server 130 of FIG. 1B and the second memory device may be located in a remote site. Alternatively, the files 205 and the IA records 200 may both be stored on a single memory device 134. Additionally or alternatively, other data may be stored in the memory device 134 including but not limited to JAM server applications, networking information, IAM user demographic or statistical information, IAM server administrator permissions, etc.

FIG. 2 further illustrates potential contents of the IA records 200. Generally, the IA records 200 include a set of related data organized into units which pertain to an intellectual asset such as a patent, a trademark, copyright, or the like. For example, the set of related data of the IA records 200 may be organized into the units including a record identifier 210, an asset type 220, an asset title 230, an asset description 240, an asset status 250, a document 260, a task 270, an event 280, and a country 290. Each of these meaningful units will be briefly discussed below.

With respect to the embodiment illustrated in FIG. 2, the record identifier 210 is an identifier uniquely identifying the IA record 200 and may be used to reference the IA record 200. The asset type 220 may be used to distinguish between various types of intellectual assets, such as patents, trademarks, copyrights, trade secrets, etc. The asset title 230 may provide a human-readable name for the IA record 200, and the asset description 240 may provide a human-readable summary of the IA record 200. The asset status 250 may indicate the current status such as pending, abandoned, issued, etc. of the intellectual asset associated with the IA record 200. The country 290 may indicate a jurisdiction in which the corresponding intellectual asset is to be, or has been, filed.

Examples of the document 260 may include but are not limited to an archive, a record, a report, a paper, an article, a reference, a response, an action, a correspondence, a memorandum, an audio recording, a video recording, a photo, or a drawing. The document 260 may be associated with the IA record 200 by being linked to the IA record 200. The link between the IA record 200 and the document 260 may be implemented through various techniques which may include, storing in the IA record 200 a file path to the document 260, storing in the IA record 200 a database reference to the document 260, and the like. Additionally, the document 260 may be stored within the IA record 200 as illustrated in FIG. 2 or alternatively, the document 260 may be stored separately from the IA record 200.

In the embodiment illustrated in FIG. 2 there is one document 260 associated with the IA record 200. However, the document 260 may be a plurality of documents 260 which may include various examples listed above. Additionally or alternatively, the plurality of documents 260 may be associated with one IA record 200, the plurality of documents 260 may be associated with multiple IA records 200, or some subset of the plurality of documents 260 may be associated with one or more IA records 200 within the IAM system 100 (FIG. 1A). Once the file 205 is associated with the IA records 200, the file 205 is also referred to as the document 260.

Generally, the task 270 denotes an action for a specified IAM user to complete by a specified time. Some examples of the task 270 may include but are not limited to instructing outside counsel, attending meetings, etc. Like the document 260, the task 270 may be a plurality of tasks 270. That is, multiple tasks 270 may be, and commonly are, associated with the IA record 200.

The event 280 records important event information in the lifecycle of the IA record 200, and the event 280 includes an event name, event date, event description, and an indication of what user caused event recording. An example of what the event 280 may record is an office action sent for an intellectual asset. Like the task 270, the event 280 may be a plurality of events 280. That is, multiple events 280 may be, and commonly are, associated with the IA record 200.

In alternative embodiments, the IA record 200 may include a set of related data which may be organized into meaningful units that may include any subset of those meaningful units listed above or may include various others not listed. For example, an embodiment of an IA record 200 may include a record identifier 210, a document 260, a task 270, and an event 280 and omit the asset type 220, the asset title 230, the asset description 240, and/or the asset status 250.

As stated above with reference to FIG. 1A, the IAM system 100 enables the user device 110 to access the IAM server 130 to obtain the IAM service. Some example solutions for accessing the IAM server 130 include an IAM client software and/or a web browser loaded on the user device 110. Alternatively, the user device 110 may communicate with the IAM server 130 through a remote desktop connection. In embodiments with the web browser, the IAM server 130 provides the IAM service as a web application.

To provide the IAM service, examples of the IAM system 100 may allow the IAM user to interface with the IAM server 130. The interface between the IAM user and the IAM server 130 may utilize user interface (“UI”) objects. The UI objects provide the IAM user information related to a specific meaningful unit. Additionally or alternatively the set of UI objects may allow the IAM user to modify the information contained in the meaningful units.

With regard to survey template creation and survey completion, an IAM user may be a survey administrator for survey template creation or a survey end user for survey completion. Depending on the configuration of the IAM system 100, the UI objects may be created and provided to the IAM user differently. For example, the UI objects may be created by the IAM server 130 and may be provided to the web browser loaded on the user device 110. In this embodiment, the web browser renders the UI objects which may be described in HTML, JavaScript, CSS or an equivalent language. In alternative embodiments, the UI objects may be implemented as a dedicated client on the user device 110 or the UI objects may be implemented the IAM server 130 for directing interfacing by the IAM user.

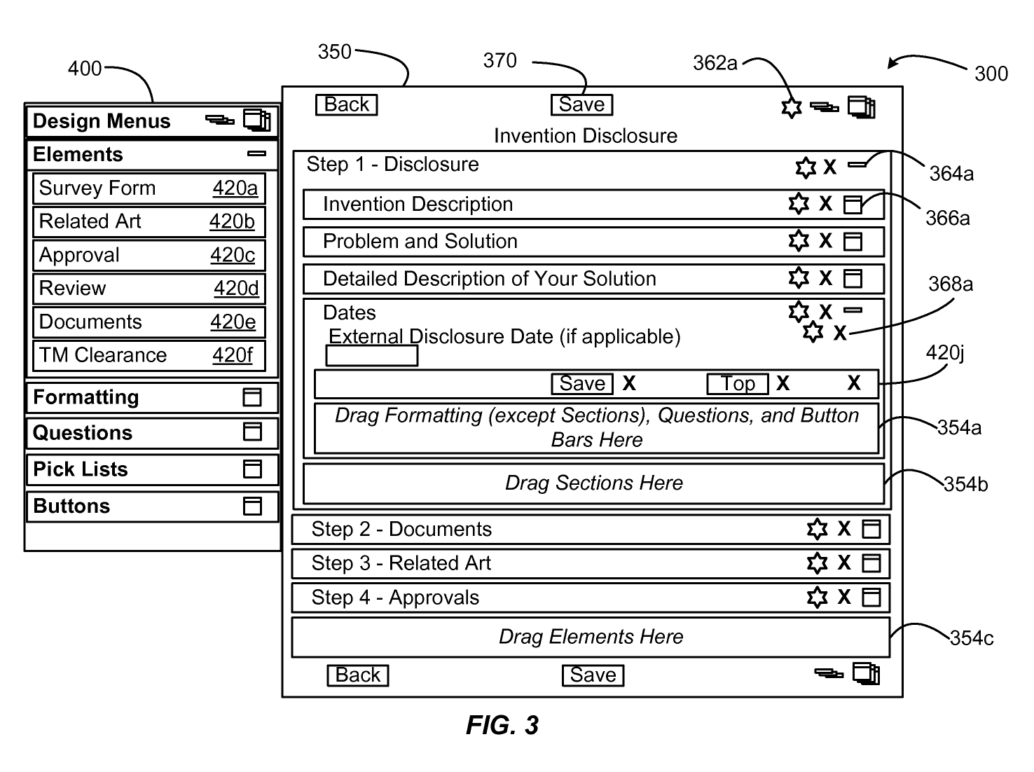

Turning next to FIG. 3, details of a survey template designer UI object 300 are disclosed. Illustrated in FIG. 3, the survey template designer UI object 300 enables an IAM user to perform drag-and-drop survey template creation for IA record information entry, storage, update, and workflow in accordance with an example embodiment. The survey template designer UI object 300 in FIG. 3 illustrates survey template design for an invention disclosure submission, though the survey template designer UI object 300 may be utilized to create any type of IA record information entry interface, such as for a trademark search request, a non-disclosure agreement request, an intellectual property review request, and the like. While the survey template designer UI object 300 in FIG. 3 illustrates survey template design through drag-and-drop survey components 420, any other survey template design options may additionally or alternatively be utilized to create survey templates, such as a shortcut key selection, an interface pointer “insert here” paradigm, UI object selection for automatic insertion, etc.

The area on the left of the example survey template designer UI object 300, a survey component UI object 400 for survey template creation, contains various different survey components 420 listed under a “Design Menus” heading from which the survey template may be constructed. The larger area to the right of the example survey template designer UI object 300 contains a preview area UI object 350 of the survey template being constructed. A survey administrator may, for example, construct the survey template by dragging chosen survey components 420 onto the preview area UI object 350. On-screen hints 354 may be provided informing the survey administrator which survey components may be added to the preview area, such as the on-screen hints 354 “Drag Formatting (excepts Sections), Questions, and Button Bars Here” 354a; “Drag Sections Here” 354b; and “Drag Elements Here” 354c. Once survey components 420 have been added to the preview area UI object 350, the survey components 420 may be reordered by dragging and dropping into desired positions. Also, once survey components 420 have been added to the preview area UI object 350, survey components 420 may be edited through survey administrator selection of a settings UI object 362, such as a survey header settings UI object 362a shown in FIG. 3. Some survey components 420, such as elements, questions, and sections may provide expandable and collapsible panels, with the panels collapsible through survey administrator selection of a panel expand UI object 364, such as panel expand UI object 364a. The panels are expandable through survey administrator selection of a panel expand UI object 366, such as panel expand UI object 366a. The Survey components 420 may be removed from the preview area UI object 350 through survey administrator selection of an “X” closure UI object 368, such as closure UI object 368a. The survey administrator may select a “Save” button 370 to have the intellectual asset IAM server 130 save modifications made to the survey template to the memory device 134. The “Save” button 370 is used for saving the survey template, while a “Save” button 420aa dragged and dropped onto a button bar component 420j is not actionable for the survey template but may be selected by the survey end user at survey runtime to save the corresponding survey. If a survey has already been completed based upon the survey template, a previous version of the survey template may be retained for historic purposes and to ensure that surveys completed before the survey template was modified continue to remain accessible.

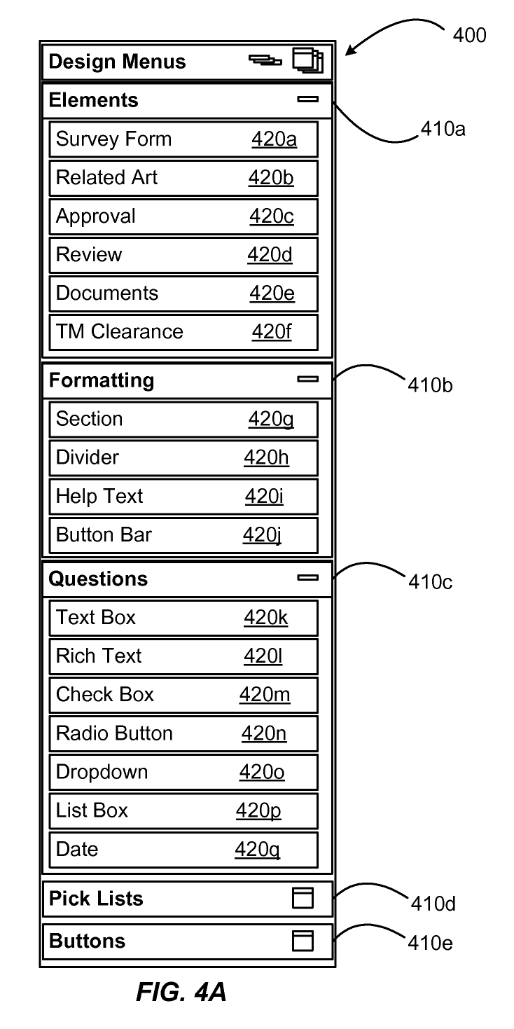

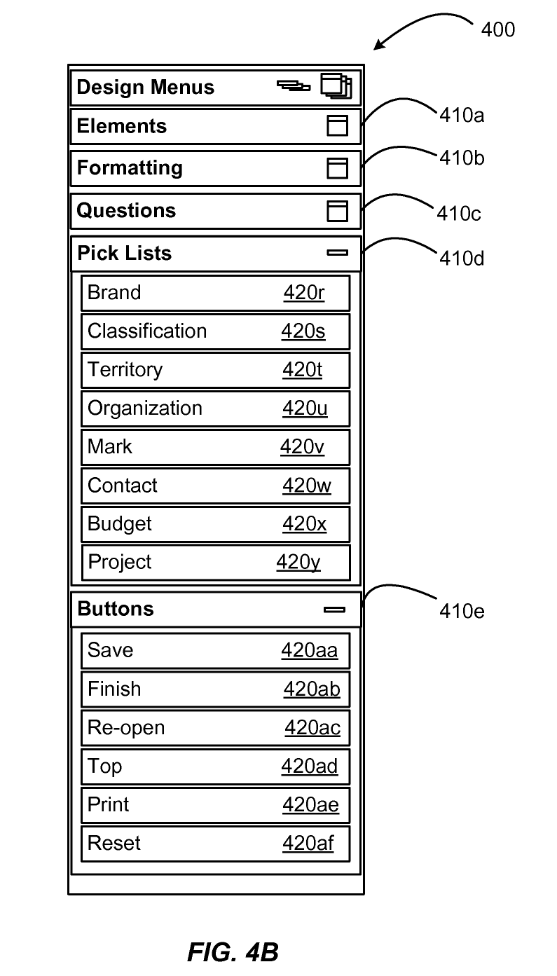

Turning next to FIGS. 4A and 4B, the survey component UI object 400 for survey template creation is illustrated in additional detail. The survey component UI object 400 is also illustrated on the left side within the survey template design UI object 300 of FIG. 3. Each of the various survey components 420 listed within FIGS. 4A and 4B are described below. Expandable and collapsible menu panels 410 are provided in the survey component UI object 400 to group together logically related survey components 420. In FIG. 4A, the survey component UI object 400 has an “Element” menu panel 410a, a “Formatting” menu panel 410b, and a “Questions” menu panel 410c, all of which are shown expanded so as to illustrate the various survey components 420 therein. A “Pick Lists” menu panel 410d and a “Buttons” menu panel 410e are also illustrated in FIG. 4A within the survey component UI object 400, with both of these panels shown collapsed. In FIG. 4B, the same five panels 410 of the survey component UI object 400 are illustrated, however now the “Pick Lists” menu panel 410d and the “Buttons” menu panel 410e are both expanded, with other panels 410 shown collapsed.

### Elements

A survey runtime of the IAM server 130 may either display all elements of a runtime survey at once as a series of collapsible panels in a survey or one at a time in the manner of a step-by-step wizard survey. A “Survey Header” (not shown) may be considered a survey element, but may also be an element which cannot be removed from the preview area, so the “Survey Header” does not appear in the “Elements” menu panel. The “Survey Header” may include a survey title, a survey description, a survey type, a survey display mode, a survey IA record mapping, and a default IA record status value. The survey title is a title for the survey, and may be displayed at survey runtime at the top of the survey. In FIG. 3, the survey title is shown as “Invention Disclosure”. The IAM user may access and edit other constituent units of the “Survey Header” by selecting the survey header settings UI object 362a of FIG. 3. The survey description includes a description of the survey, and may also be displayed to a survey user at survey runtime. The survey type may be used to specify the type of survey—for example, an invention disclosure, a trademark search request, a non-disclosure agreement request, an IP review request, or the like. The survey display mode allows the survey administrator to specify whether to display all elements at once as a series of collapsible panels or one at a time in the manner of a step-by-step wizard. The survey IA record mapping may be utilized by the survey administrator to specify the asset type 220 of IA record 200 to map the survey data into—for example, a patent record, a trademark record, an agreement record, etc. The default IA record status value specifies the initial asset status 250 for the newly-created IA record 200.

A “Survey Form” element 420a allows a survey administrator to design custom data input forms for survey user data entry. The “Survey Form” element 420a may include a title and optional instructions, with the title shown in FIG. 3 as “Step 1—Disclosure”. The following survey components may be added to the “Survey Form” element 420a: all types of formatting components from the “Formatting” menu panel 410b; all question components from the “Questions” menu panel 410c; and any other appropriate survey components.

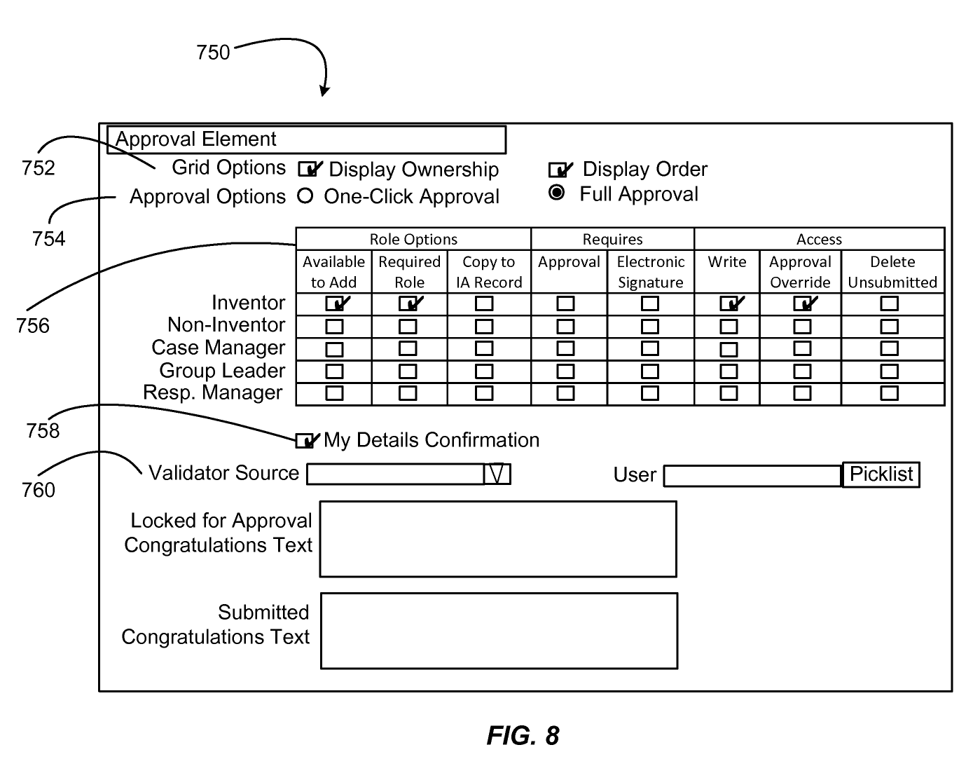

“Documents” and “Related Art” elements 420e and 420b, respectively, may allow a survey end user to specify and upload files to associate with a newly-created IA record 200 created upon completion of survey entry. In FIG. 3, the “Documents” element 420e is shown in the collapsed panel with the title “Step 2—Documents”, and the “Related Art” element 420b is shown in a collapsed panel with the title “Step 3—Related Art”. An example use of an “Approval” element 420c is shown in FIG. 3 in a collapsed panel with the title “Step 4—Approvals”. Further details regarding the “Approval” element 420c are provided later in reference to FIG. 8.

A “Review” element 420d provides the survey administrator the ability to specify review-related details for the survey template, with review details including review committee, reviewers, review deadlines, and/or review form. A “TM Clearance” element 420f provides the survey administrator the ability to prompt the survey end user for trademark clearance request information in a runtime survey associated with the survey template.

### Formatting

A section component 420g may be added to “Survey Form” elements 420a. The section component 420g may be used to logically group data being collected on the survey, and the section component 420g includes a section name displayed at survey runtime. For example, panels within the survey template designer UI object 300 of FIG. 3 with section names “Invention Description”, “Problem and Solution”, “Detailed Description of Your Solution”, and “Dates” are all sections within the “Survey Form” element 420a. The following survey components may be added to the section component 420g: all types of formatting components, except other section components 420g from the “Formatting” menu 410b; all question components from the “Questions” menu 410c; and any other appropriate survey components.

A divider component 420h may be added to any type of element. The divider component 420h does not have any associated metadata, and no other survey components may be added to the divider component 420h. The divider component 420h provides a horizontal line used to visually separate survey components.

A help text component 420i may be added to all elements and sections. The help text component 420i may be added to a survey template to provide additional guidance and instructions to the survey end user on how to complete the survey. No other survey components may be added to the help text component 420i.

The button bar component 420j may be added to section components 420g, and may be used to add buttons to the survey template. Buttons are described in further detail below with reference to the “Buttons” menu panel 410e in the survey component UI object 400.

### Questions

A question component may only be added to a section, and no other survey components may be added to the question component. Each question component -- for example, text box 420k, rich text 4201, check box 420m, radio button 420n, dropdown 420o, list box 420p, date 420q -- may have two sets of metadata. The first set of metadata may be a common set of metadata shared across all question components. The second set of metadata may be specific to the particular question component.

Metadata common to all question components may include question text, question details, help text, a mandatory indication, a hidden indication, a field mapping, and a display condition. An example of the question text is provided in FIG. 3 within the “Dates” section as “External Disclosure Date (If Applicable)”. The optional question details provide instructions to the survey end user explaining what information may be included in the answer. The optional help text provides a detailed explanation of the question and the possible details to be received from the survey end user. The mandatory indication indicates whether a question is specified as mandatory for the survey end user to answer. The hidden indication indicates if the question should be hidden for survey end users. By hiding a question, the survey administrator may denote to pass a default value to the mapped IA record unit specified within the field mapping.

The display condition indicates a condition under which the question is displayed on the runtime survey. A current question may be designated as cascading such that a previous question's answer determines what values are provided as selectable options for the current question. Additionally, a current question may be designated as conditional, where a previous question's answer determines whether or not the current question is displayed.

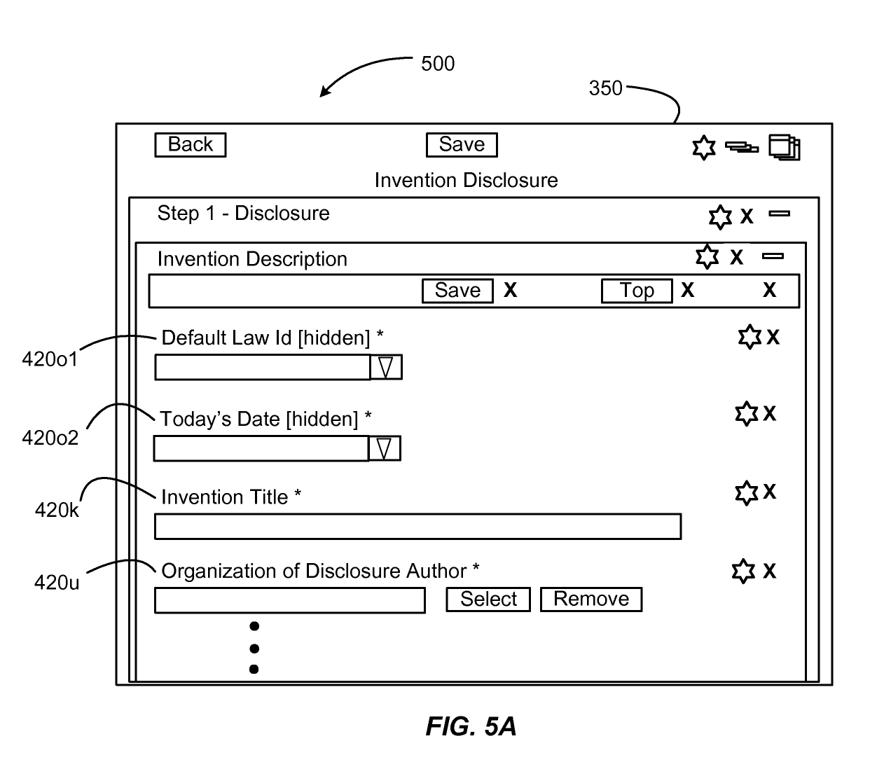

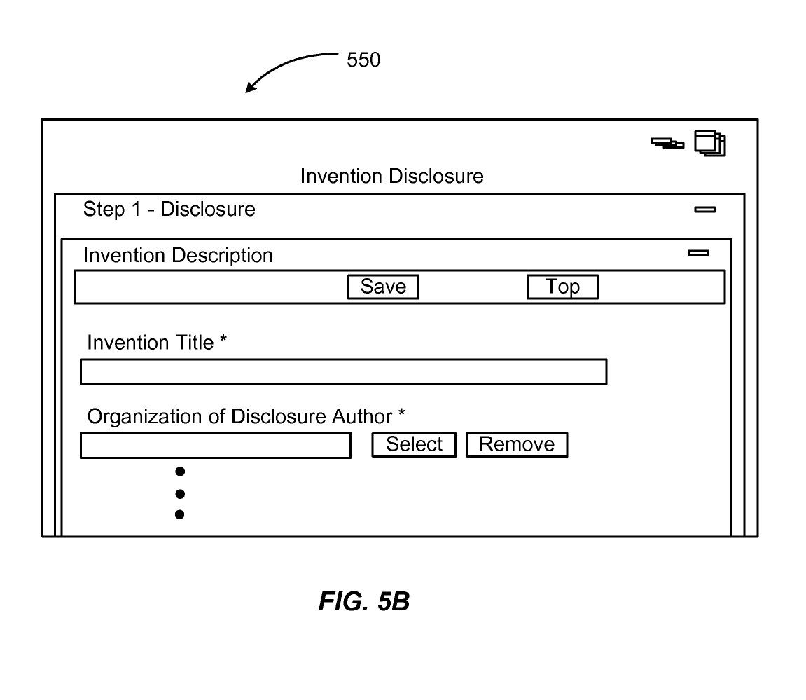

Turning now to FIG. 5A, an example invention disclosure survey template UI object 500 is illustrated. Within the preview area UI object 350, the “Invention Disclosure” section includes several question components, for example, a hidden “Default Law Id” dropdown question component 420o1; a hidden “Todays Date” dropdown question component 420o2; an “Invention Title” text box question component 420k; along with an “Organization of IDF Author” classification pick list 420s.

Turning now to FIG. 5B, an example runtime survey UI object 550 is illustrated. The runtime survey UI object 550 is based upon, and associated with, the invention disclosure survey template UI object 500 from FIG. 5A. Hidden question components such as “Default Law Id” dropdown question component 420o1 and “Todays Date” dropdown question component 420o2 are not included in the runtime survey UI object 550 because hidden question components are not displayed to the survey end user. Additionally, UI objects used within the survey template designer UI object 300 of FIG. 3 by the survey administrator to control survey components are not included in runtime survey UI objects. These survey template-only UI objects include, for example, the settings UI objects 362, the closure UI objects 368, and the survey template “Save” button 370. The survey end user interacts with the runtime survey UI object 550 to review and enter data for an invention disclosure. The specific example provided in FIG. 5B is but one of many possible examples of the runtime survey UI object 550, and in the example represents only a portion of an invention disclosure runtime survey.

### Pick Lists

Referring back to FIG. 4B, the survey component UI object 400 for survey template creation includes the “Pick Lists” menu panel 410d. The “Pick Lists” menu panel 410d includes one or more pick lists, where a pick list is an additional question component, and the survey administrator adds a pick list to the survey template to allow a survey end user to select one or more values from a predefined collection of values within the pick list. Possible pick lists include the following example pick lists shown in FIG. 4B: Brand 420r, Classification 420s, Country/Territory 420t, Legal Body/Organization 420u, Mark 420v, User/Contact 420w, Budget 420x, and Project 420y, along with additional example pick lists not shown, such as: Agreement Type, Area, Brand Element, Contact Type, Legal Body Type, Organization Umbrella, Registry Agreement Sub Type, and Retention Schedule.

Additional predefined collections of related values may be added to the “Pick Lists” menu panel 410d beyond the pick lists listed above, where the collections may include any stored intellectual asset management system data. Each type of pick list may have two sets of metadata. The first set of metadata may be a common set of metadata for all pick list types. The second set of metadata may be specific to each type of pick list type. The first set of common metadata includes a default answer for the question, an indication of whether multiple answers are allowed to be selected by the survey end user, and pick list parameters. The User/Contact pick list 420w has an additional metadata value for contact type, where the contact type may be selected using a dropdown of predefined contact types.

Each survey pick list is a wrapper for an existing predefined intellectual asset management system pick list. Each predefined pick list supports a set of parameters which may be used to control pick list behavior. For example, the Mark pick list 420v supports an indication if the pick list may return more than one value; a search string; a search type; and an exclude series selection for excluding specified types of Marks.

### Buttons

A button may only be added to the button bar 420j, and no other survey component may be added to the button. Except for a “Finish” button 420ab, buttons do not ordinarily have metadata and therefore are not editable. Buttons may only be added and removed from button bars 420j.

Selection of the “Save” button 420aa in a runtime survey first validates the provided survey end user answers, displaying error messages as appropriate. If successfully validated, the runtime survey will be saved to a saved survey according to a survey data schema. If the runtime survey is mapped to a type of IA record, the mapped data will also be saved to the appropriate IA record. A “Finish” button 420ab, or “Submit” button, functions as per the “Save” Button 420aa with the addition that all “Survey Form” elements in the survey answer set may be set to a value of “frozen”. Frozen “Survey Form” elements cannot be edited. A “Re-open” button 420ac unfreezes a frozen survey. A “Top” button 420ad navigates the survey end user to the top of the runtime survey. A “Print” button 420ae opens a pop-up displaying the survey and associated answers in a printer-friendly format. A “Reset” button 420af discards any changes made to survey answers, resetting answers to the values present when the runtime survey was last saved.

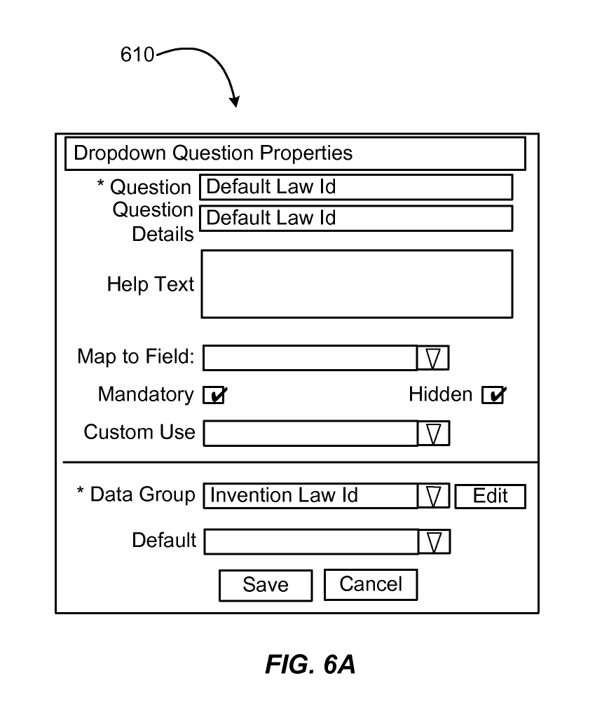

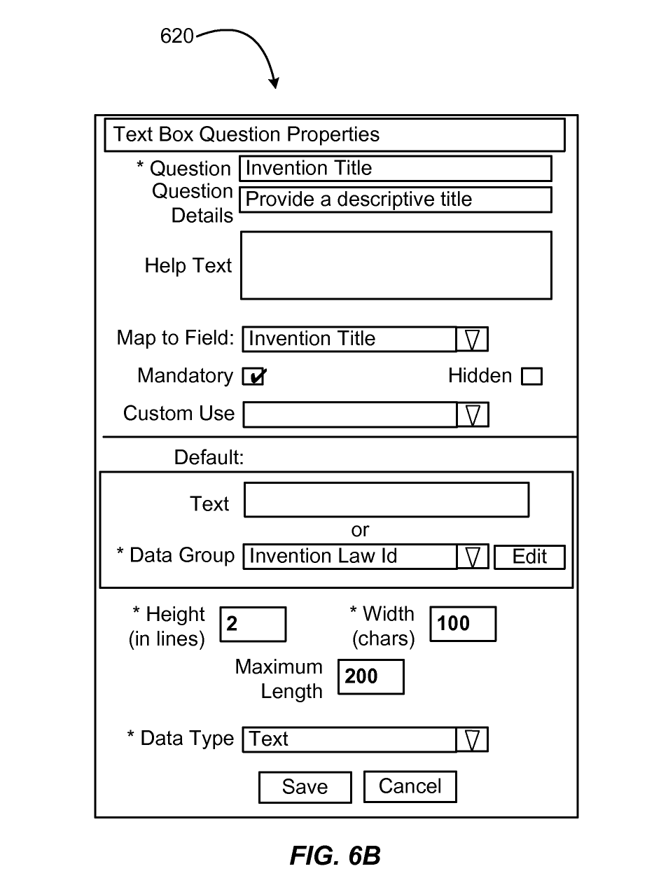

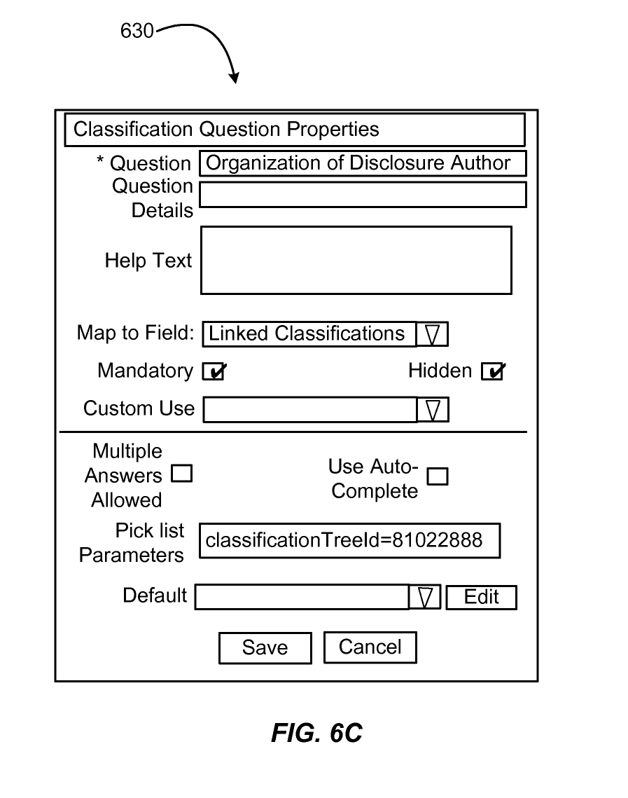

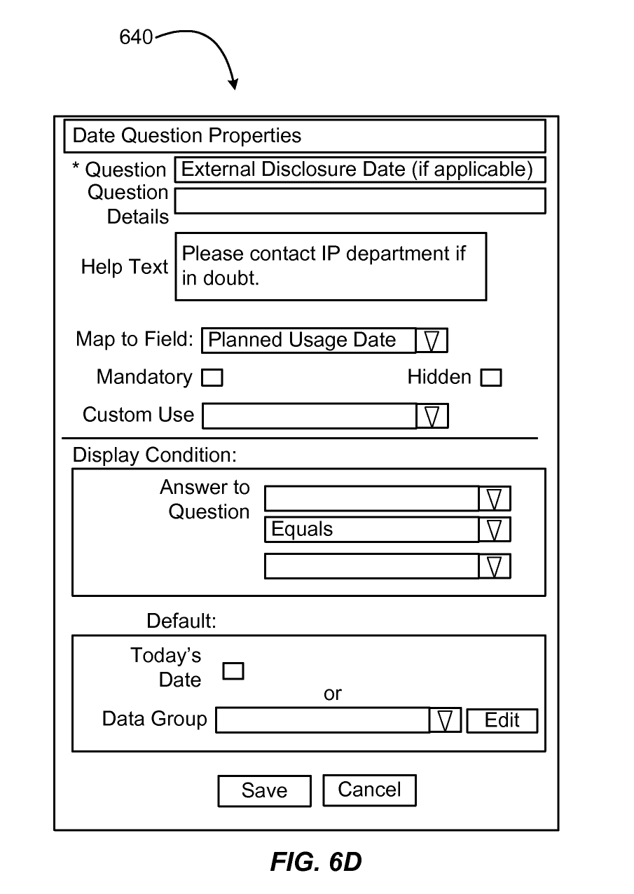

Turning next to FIGS. 6A, 6B, 6C, and 6D, example question properties for various types of survey questions are illustrated.

A dropdown question properties UI object 610 is provided in FIG. 6A. The survey administrator interacts with the dropdown question properties UI object 610 to specify properties for a given question of dropdown type. In addition to the common set of metadata for all question components, the dropdown question properties UI object 610 may include metadata fields specific to the dropdown question component. The additional dropdown metadata fields may include a default answer; a data group which specifies an answer set for the current question (in FIG. 6A the data group is indicated as “Invention Law Id”); and a cascading filter question allowing for selection of a different question, where the answer to the different question will be applied as a filter to the answers for the current question. In the example provided in FIG. 6A, because the question is hidden, the survey end user does not have an opportunity to select an answer to the dropdown question—instead, the answer is defaulted already to the “Invention Law Id” which would likely have one static value. A different example for the dropdown question component where the survey end user would have an opportunity to select one answer from a plurality of possible answers would be, for example, using a data group for “Submitter's Employer” where the data group includes several different possible answers using company names from which the survey end user could select.

A text box question properties UI object 620 is provided in FIG. 6B. The survey administrator interacts with the text box question properties UI object 620 to specify properties for a given question of text box type. In addition to the common set of metadata for all question components, the text box question properties UI object 620 may include metadata fields specific to the text box question component. The additional text box metadata fields may include a default answer for the question; a height of the text box; a width of the text box; a maximum character length; and a data type, where the data type may be one of text, integer, or decimal.

A pick list question properties UI 630 object is provided in FIG. 6C. The survey administrator interacts with the pick list question properties UI object 630 to specify properties for a given question of pick list type. In addition to the common set of metadata for all question components, the pick list question properties UI object 630 includes metadata fields specific to the pick list question component. As described earlier, the additional pick list metadata fields are specific to the type of pick list—in FIG. 6C, the pick list is the Classification 420s pick list. For the classification pick list 420s, additional metadata fields may include an indication of whether multiple answers are allowed; an indication of whether to utilize auto-completion; pick list parameters; and a default value. The pick list parameters in the example of FIG. 6C are specific to the classification pick list type, and as illustrated control which classification tree is to be utilized for the classification pick list 420s—for example, an “Organization” classification tree.

A date question properties UI object 640 is provided in FIG. 6D. The survey administrator interacts with the date question properties UI object 640 to specify properties for a given question of date type. In addition to the common set of metadata for all question components, the date question properties UI object 640 may include metadata fields specific to the date question component 420q. The additional date metadata fields may include a default answer for the question—whether the date of the day when the survey is completed or a chosen value from a data group.

Similar question properties UI objects and associated metadata fields may be provided for other question components such as rich text 4201, check box 420m, radio button 420n, and list box 420p. The specific examples provided in FIGS. 6A, 6B, 6C, and 6D are but four of many possible examples of question properties for various types of survey questions.

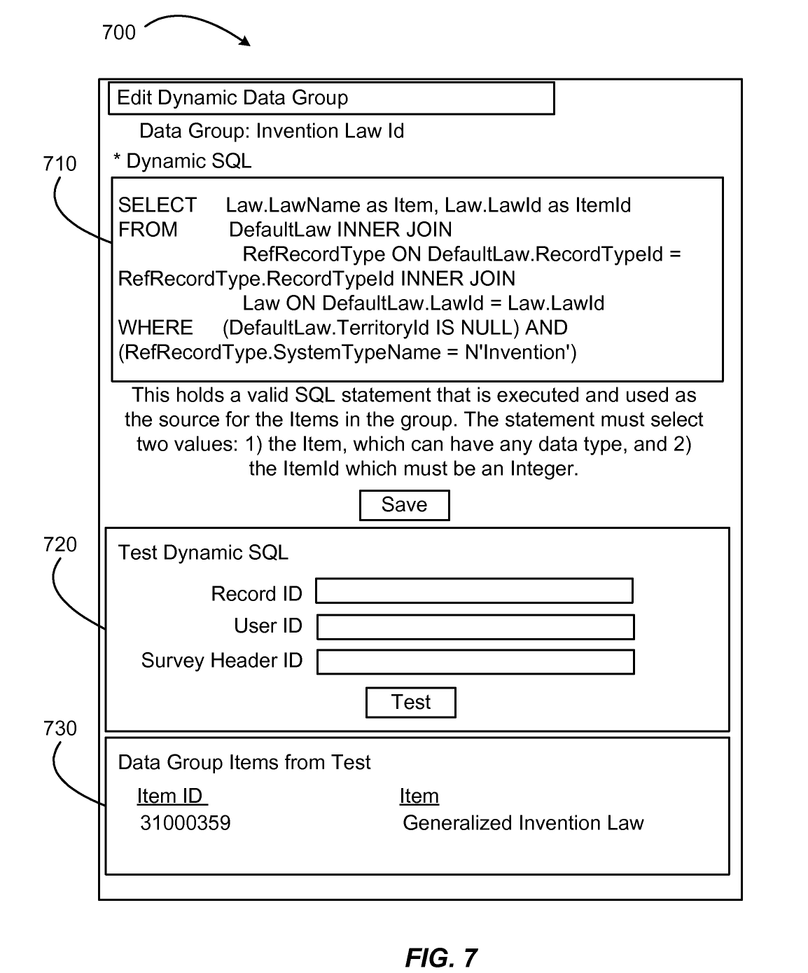

Turning next to FIG. 7, a data group management UI object 700 is illustrated. The data group may be specified for a given question to extract a default answer to a question based upon any selected data stored within the intellectual asset management system. The data group management UI object 700 may be used by the survey administrator to update, view results, and test the data group. The data group may be a defined static set of possible values or a dynamic data query to extract values real-time from the intellectual asset management system. The example data group management UI object 700 as illustrated in FIG. 7 illustrates utilization of a dynamic data group, where the dynamic data group is obtained through a specified Structured Query Language (SQL) query to extract IA record data from specified columns within specified database tables. The example illustrated in FIG. 7 includes a SQL query 710 to obtain the “Invention Law Id” data group specified as the chosen data group for the dropdown question illustrated in the dropdown question properties UI object 610 of FIG. 6A. A test section 720 of the data group management UI object 700 allows test values to be entered for dynamic criteria to show results 730 of the dynamic query 710 when executed. The specific example provided in FIG. 7 is but one of many possible examples of the data group management UI object 700.

Turning next to FIG. 8, a survey approval properties UI object 750 is illustrated. Grid options 752 “Display Ownership” and “Display Order” may determine if the runtime survey includes ownership and order columns for listed inventors for a survey template of invention disclosure type. An approval option 754 may determine whether the survey end user may perform a one-click submit or the survey end user must obtain specified approvals as described in further detail below. A main grid 756 for configuring approvals may be a matrix consisting of assignment of roles (in rows) and provided capabilities (in columns). Roles “Inventor” and “Non-Inventor” are only applicable, and thus displayed, for a survey template of invention disclosure type. Roles are configurable and may be added to the intellectual asset management system through other methods (not shown), and include example values such as “Case Manager”, “Responsible Manager”, “Group Leader”, “Committee Chairperson”, “Law Firm Case Manager”, “Technology Coordinator”, “Award Manager”, and similar values, and these roles are assigned to IAM system users.

The columns may be grouped into three sections: “Role Options” group, “Requires” group, and “Access” group. For the “Role Options” group, “Available to Add” sets whether the end user filling out the survey will be able to add contacts/users having the specified role; “Required Role” sets a requirement that the specified role must be added in order to save and continue through the approval process; and “Copy to IP Record” sets whether the contact assigned to the specified role will get copied to the IA record 200 after submission of the survey. For the “Requires” group, “Approval” determines whether the specified role will be required to review and select an “Approval” or “Rollback” button in order to continue the survey process through to submission; and “Electronic Signature” determines whether the specified role will be required to review and provide an electronic signature and then select an “Approval” button in order to continue the survey process through to submission. For the “Access” group, “Write” determines whether the specified role for the IA record 200 will have an ability to modify or update any element of the survey submission; “Override Approval” determines whether the specified role has the ability to roll back the approval and submission; and “Delete Unsubmitted” determines whether the specified role may delete an unsubmitted survey.

A “My Details Confirmation” checkbox 758 indicates whether to require all approvers to receive a “My Details” page after selecting either the “Approve” button, “Override Approval” button or “Finish”/“Submit” button. A “Validator Source” section 760 designates a contact/user of the intellectual asset management system, where the “Validator Source” is assigned to validate a submitted survey. The specific example provided in FIG. 8 is but one of many possible examples of the survey approval properties UI object 750.

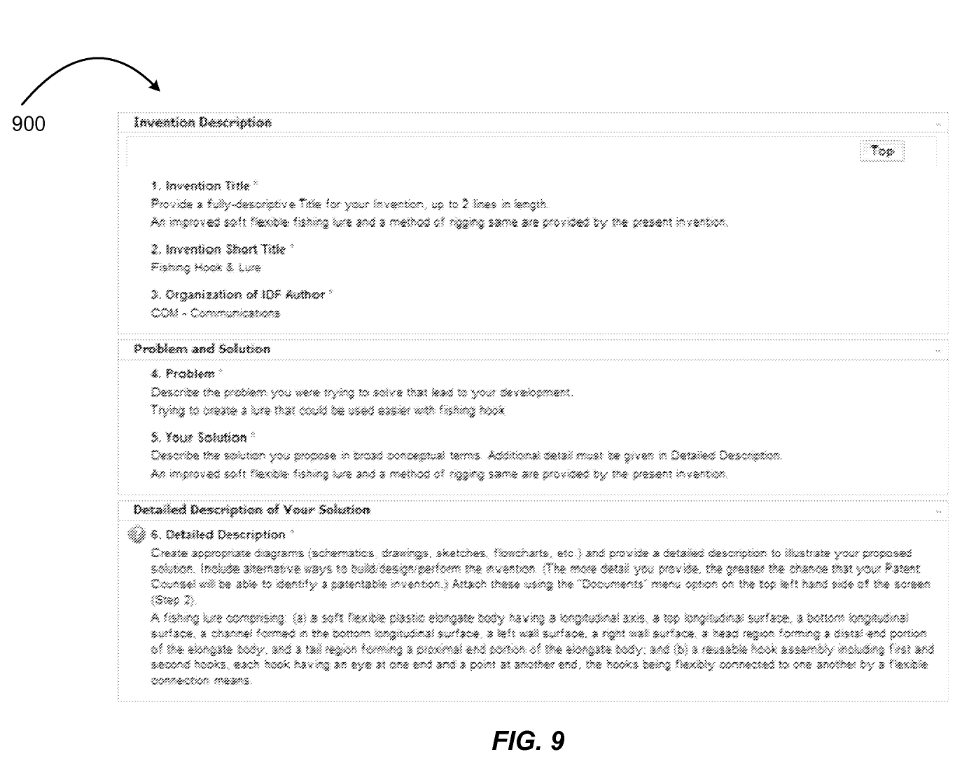

Turning next to FIG. 9, a completed survey UI object 900 is illustrated showing a completed invention disclosure survey with answers provided for all shown questions. For example, within an “Invention Description” section, a first question “Invention Title” includes an answer earlier provided by the survey end user as “An improved soft flexible fishing lure and a method of rigging same are provided by the present invention.” The invention disclosure survey shown in the completed survey UI object 900 may have been created as an invention disclosure survey template by the survey administrator using the invention disclosure survey template UI object 500 illustrated in FIG. 5A, and the invention disclosure survey may have been provided as a runtime survey for the survey end user to interact with and submit such as the runtime survey UI object 550 illustrated in FIG. 5B. The specific example provided in FIG. 9 is but one of many possible examples of the completed survey UI object 900.

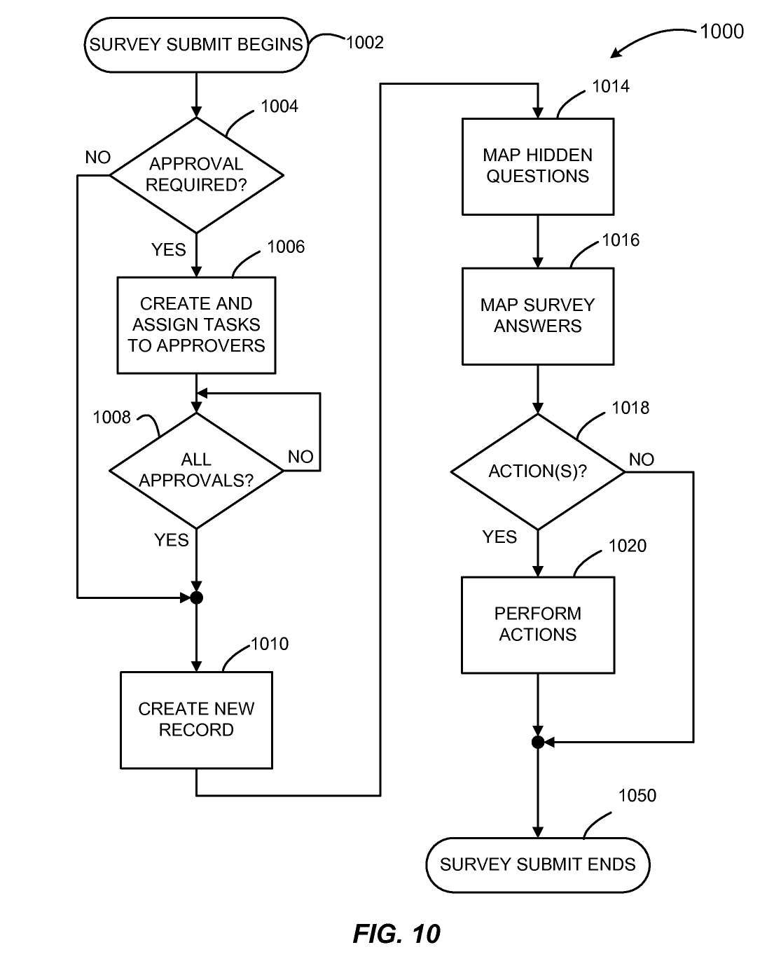

Turning now to FIG. 10, the IAM system includes a law engine (not shown), where the law engine is a configurable condition-action workflow model defining one or more actions to be taken upon occurrence of a specified condition. The survey administrator may configure and utilize the workflow of the law engine to cause actions to be taken upon conditions occurring through runtime survey submission, approval, or update. Survey workflow may be triggered in a variety of ways. A common way in which survey workflow may be triggered is by selection of the “Save” button or the “Finish”/“Submit” button on a runtime survey. When the law engine is invoked, the trigger mechanism—for example, the “Submit” button on the approval element being selected—may be conveyed to the law engine along with the intellectual asset data to be processed. The law engine workflow may be defined to take one or more specified actions based upon one or more of survey submission, survey approval, survey update, file upload, and a question's answer. Referring to FIG. 10, a flow diagram is provided depicting an example method 1000 for creating an IA record 200 and triggering workflow based upon survey submission. The IA record creation and workflow process 1000 may be performed by an electronic device, such as the IAM server 130.

At 1002 the IA record creation and workflow process 1000 begins upon submission of a completed survey by a survey end user. At step 1004 the controller 132 of the IAM server 130 determines if any approvals are required for the survey based on settings the survey administrator entered using the survey approval properties UI object 750. If approval is required, the controller 132 creates and assigns a task for each required approver to approve the submitted survey. Once all approvals have been obtained at step 1008, or if no approval was required at step 1004, the controller 132 creates a new IA record 200 of asset type 220 as directed by the survey IA record mapping of the corresponding survey template's “Survey Header”. Alternatively, survey completion may update an existing IA record 200 instead of creating a new IA record 200. The controller 132 may also set the asset status 250 for the IA record 200 to the default IA record status value specified in the “Survey Header” of the survey template for the current runtime survey. Prior to step 1014 the controller 132 may validate answers, and if answers are successfully validated, the controller 132 may save the runtime survey to a saved survey according to a survey data schema. If the runtime survey is mapped to a type of IA record, the mapped data will also be saved to the appropriate IA record. At step 1014 the controller 132 saves values from hidden questions into the corresponding mapped fields within the IA record 200, and at step 1016 the controller 132 saves values from question answers into the corresponding mapped fields within the IA record 200. As an example, for a text box question of “Invention title”, the corresponding answer provided by the survey end user may be mapped into the asset title 230 of an IA record of asset type 220 “Invention”. There is no implied ordering of steps 1014 and 1016—step 1016 may be performed prior to step 1014, or both steps may be performed simultaneously. If survey submission or any of the IA record field values are recorded within the law engine as conditions, then at step 1018 the controller 132 determines what corresponding action or actions are required, and the controller 132 performs each required action. The controller 132 performs actions at step 1020 such as recording one or more events 280 and opening one or more tasks 270. The IA record creation and workflow process 1000 ends at 1050 and is considered completed. Example process 1000 may be modified in any of numerous ways, such as by performing the steps in a different order than described, by performing additional steps, by omitting one or more of the steps described, etc.

Through survey template creation and management, the survey administrator simplifies IA record creation and updating along with approval management for a survey end user. In addition to the IA record creation and workflow process 1000 of FIG. 10, access to each survey may be limited to specified users, roles, and/or groups. Survey end users, through several embodiments of the present application, are not required to input information for, or even be presented with, all fields of the record—survey end users may leverage hidden pre-configured default values for many fields. As an example, an intellectual asset management system might handle the design intellectual asset type as a subtype of the patent intellectual asset type—while designs in the United States are treated as design patents, designs are not handled as patents in many other jurisdictions around the world, so many patent IA record fields are not applicable for designs. Thus, a survey end user need not be presented those non-applicable fields when creating or updating an IA record for a design when the country 290 is not set to a value indicative of the United States. The survey administrator may design different survey forms for different situations, processes, and/or organizational divisions within a company or law firm.

Embodiments described herein may include the use of a special purpose or general-purpose computer including various computer hardware or software modules, as discussed in greater detail below.

Embodiments within the scope of the present subject matter also include tangible computer-readable media for carrying or having computer-executable instructions or data structures stored thereon. Such computer-readable media can be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer.

Computer-executable instructions include, for example, instructions and data which cause a general purpose computer, special purpose computer, or special purpose processing device to perform a certain function or group of functions. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used herein, the term “module” or “component” can refer to software objects or routines that execute on the computing system. The different components, modules, engines, and services described herein may be implemented as objects or processes that execute on the computing system (e.g., as separate threads). While the system, methods, and other means for accomplishing functions disclosed herein are preferably implemented in software, implementations in hardware or a combination of software and hardware are also possible and contemplated. In this description, a “computing entity” may be any computing system as previously defined herein, or any module or combination of modulates running on a computing system.

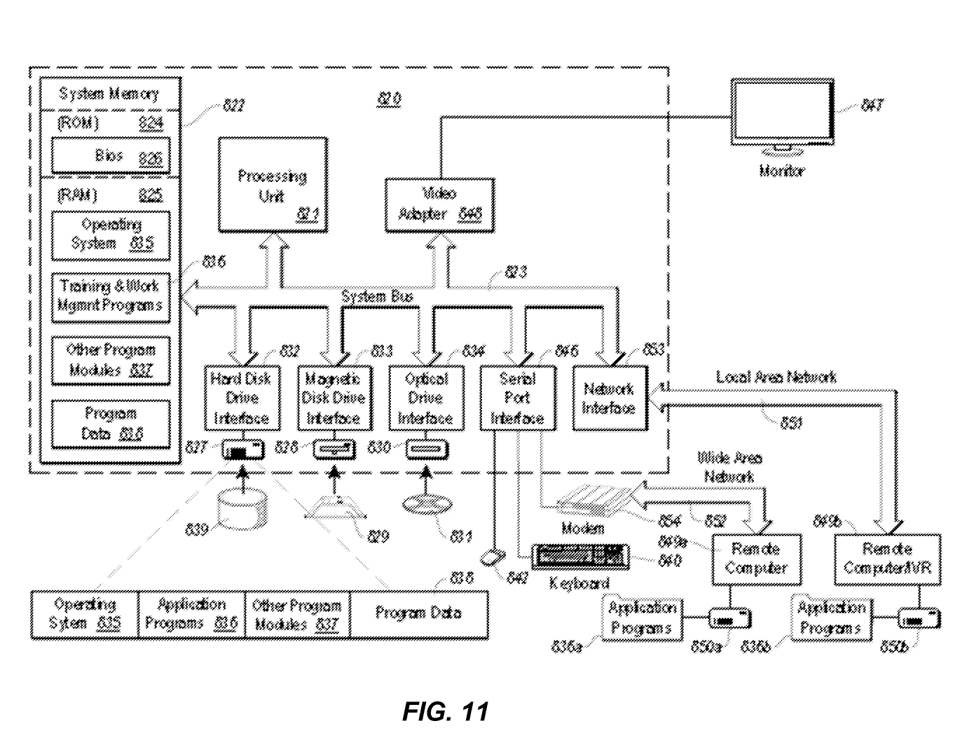

FIG. 11 and the following discussion are intended to provide a brief, general description of a suitable computing environment in which several embodiments may be implemented. For example FIG. 11 may illustrate an example of various components of an IAM server, a user device, a controller, or a memory device. FIG. 11 can also illustrate a means and steps for accomplishing various functionality and acts disclosed herein. For example, FIG. 11 as a specially programmed computer can create or update an IA record, store mapped survey answers to IA record fields, and perform other predefined actions based upon predetermined conditions associated with survey submission or approval, as well as other acts and algorithms disclosed herein. Although not required, several embodiments will be described in the general context of computer-executable instructions, such as program modules, being executed by computers in network environments. Generally, program modules include routines, programs, objects, components, data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps disclosed herein.

Those skilled in the art will appreciate that embodiments illustrated herein may be practiced in network computing environments with many types of computer system configurations, including personal computers, hand-held devices, multi-processor systems, microprocessor-based or programmable consumer electronics, network PCs, minicomputers, mainframe computers, and the like. Several embodiments may also be practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

With reference to FIG. 11, an example of an IAM system 100 for implementing several embodiments is illustrated, which includes a general purpose computing device in the form of a conventional computer 820, including a processing unit 821, a system memory 822, and a system bus 823 that couples various system components including the system memory 822 to the processing unit 821. The system bus 823 may be any of several types of bus structures including a memory bus or memory controller, a peripheral bus, and a local bus using any of a variety of bus architectures. The system memory includes read only memory (ROM) 824 and random access memory (RAM) 825. A basic input/output system (BIOS) 826, containing the basic routines that help transfer information between elements within the computer 820, such as during start-up, may be stored in ROM 824. Such components, or similar components, may also embody a workstation for a company representative.

The computer 820 may also include a magnetic hard disk drive 827 for reading from and writing to a magnetic hard disk 839, a magnetic disk drive 828 for reading from or writing to a removable magnetic disk 829, and an optical disk drive 830 for reading from or writing to removable optical disk 831 such as a CD-ROM, DVD, or other optical media. The magnetic hard disk drive 827, magnetic disk drive 828, and optical disk drive 830 are connected to the system bus 823 by a hard disk drive interface 832, a magnetic disk drive-interface 833, and an optical drive interface 834, respectively. The drives and their associated computer-readable media provide nonvolatile storage of computer-executable instructions, data structures, program modules and other data for the computer 820. Although the environment described herein employs a magnetic hard disk 839, a removable magnetic disk 829 and a removable optical disk 831, other types of computer readable media for storing data can be used, including magnetic cassettes, flash memory cards, digital versatile disks, Bernoulli cartridges, RAMs, ROMs, millipede memory, and the like.

Program code means including one or more program modules may be stored on the hard disk 839, magnetic disk 829, optical disk 831, ROM 824 or RAM 825, including an operating system 835, one or more training and work management programs 836, other program modules 837, and program data 838, such as company representative proficiencies and status. A user may enter commands and information into the computer 820 through keyboard 840, pointing device 842, or other input devices (not shown), such as a microphone, joy stick, game pad, satellite dish, scanner, or the like. These and other input devices are often connected to the processing unit 821 through a serial port interface 846 coupled to system bus 823. Alternatively, the input devices may be connected by other interfaces, such as a parallel port, a game port, or a universal serial bus (USB). A monitor 847 or another display device is also connected to system bus 823 via an interface, such as video adapter 848. In addition to the monitor, personal computers typically include other peripheral output devices (not shown), such as speakers and printers.

The computer 820 may operate in a networked environment using logical connections to one or more remote computers, such as remote computers 849a and 849b. Remote computers 849a and 849b may each be another personal computer, a server, a router, a network PC, workstations of company representatives, a peer device or other common network node, and typically include many or all of the elements described above relative to the computer 820, although only memory storage devices 850a and 850b and their associated application programs 836a and 836b have been illustrated in FIG. 11. The logical connections depicted in FIG. 11 include a LAN 851 and a WAN 852 that are presented here by way of example and not limitation. Such networking environments are commonplace in office-wide or enterprise-wide computer networks, intranets and the internet.

When used in a LAN networking environment, the computer 820 is connected to the local network 851 through a network interface or adapter 853. When used in a WAN networking environment, the computer 820 may include a modem 854, a wireless link, or other means for establishing communications over the wide area network 852, such as the internet. The modem 854, which may be internal or external, is connected to the system bus 823 via the serial port interface 846. In a networked environment, program modules depicted relative to the computer 820, or portions thereof, may be stored in the remote memory storage device. It will be appreciated that the network connections shown are example and other means exist for establishing communications over wide area network 852.

The previously described embodiments have many advantages, including providing a drag-and-drop intellectual asset survey design interface, creating and populating IA records based on survey answers, linking surveys to workflow, dynamically defining what roles need to approve a submitted survey, and publishing a survey for a defined limited set of survey users. All advantageous features and all advantages need not be incorporated into every embodiment.

The present subject matter may be embodied in other specific forms without departing from its spirit or essential characteristics. The described embodiments are to be considered in all respects only as illustrative and not restrictive. The scope is, therefore, indicated by the appended claims rather than by the foregoing description. All changes which come within the meaning and range of equivalency of the claims are to be embraced within their scope.

What is claimed is:

1. A method of creating a template for an intellectual asset survey within an intellectual asset management (IAM) system, the method comprising:
providing survey components to an IAM system administrator via an IAM system user interface;
enabling the IAM system administrator to organize the survey components on a preview area of the user interface; and
in response to the survey components organization on the preview area, creating the intellectual asset survey template.

2. The method of claim 1, further comprising displaying a runtime survey on the IAM system user interface, wherein the runtime survey is based at least in part on the intellectual asset survey template.

3. The method of claim 2, further comprising accepting input from an IAM system user into the runtime survey.

4. The method of claim 3, further comprising populating at least one data unit within an intellectual asset record stored in the IAM system based at least in part on the user input.

5. The method of claim 2, wherein at least one of the survey components on the preview area comprises a hidden question.

6. The method of claim 5, further comprising populating at least one data unit within an intellectual asset record stored in the IAM system based at least in part on the hidden question.

7. The method of claim 3, further comprising executing predefined workflow based upon a condition triggered by the user input.

8. The method of claim 7, wherein the workflow comprises creating a task directed to a survey approval user, wherein the survey approval user is identified in at least one survey component in the survey template.

9. The method of claim 2, further comprising displaying the runtime survey only to a predetermined set of IAM system users.

10. A computer storage medium having computer executable instructions stored thereon for performing the method of claim 1.

11. An intellectual asset management (IAM) server of an IAM system, the IAM server comprising:
at least one memory device for storing one or more intellectual asset records; and
a controller operatively connected to the at least one memory device, wherein the controller is configured to:
provide intellectual asset survey components to an IAM system administrator via an IAM system user interface;
enable the IAM system administrator to organize the survey components on a preview area of the user interface; and
in response to the survey components organization on the preview area, create an intellectual asset survey template.

12. The IAM server of claim 11, wherein the controller further displays a runtime survey on the IAM system user interface, wherein the runtime survey is based at least in part on the intellectual asset survey template.

13. The IAM server of claim 12, wherein the controller further accepts input from an IAM system user into the runtime survey.

14. The IAM server of claim 13, wherein the controller further populates at least one data unit within an intellectual asset record stored in the IAM system based at least in part on the user input.

15. The IAM server of claim 12, wherein at least one of the survey components on the preview area comprises a hidden question.

16. The IAM server of claim 15, wherein the controller further populates at least one data unit within an intellectual asset record stored in the IAM system based at least in part on the hidden question.

17. The IAM server of claim 13, wherein the controller further executes predefined workflow based upon a condition triggered by the user input.

18. The IAM server of claim 17, wherein the workflow comprises creating a task directed to a survey approval user, wherein the survey approval user is identified in at least one survey component in the survey template.

19. The IAM server of claim 12, wherein the controller further displays the runtime survey only to a predetermined set of IAM system users.
